(19) United States
(12) Patent Application Publication
(10) Pub. No.: US 2015/0339599 A1
(43) Pub. Date: Nov. 26, 2015

(54) SYSTEM, MOBILE DEVICE AND METHOD FOR ELECTRONIC TICKET PEER TO PEER SECURE TRANSFERRING BY NEAR FIELD COMMUNICATION (NFC) TECHNOLOGY

(71) Applicant: National Cheng Kung University, Tainan City (TW)

(72) Inventors: Wei-Hsun LEE, Tainan City (TW); Wei-Jeng WU, Tainan City (TW); Yu-Sin LEE, Tainan City (TW); Chuen-Yih CHEN, Tainan City (TW); Dung-Ying LIN, Tainan City (TW)

(21) Appl. No.: 14/720,958

(22) Filed: May 25, 2015

(30) Foreign Application Priority Data
May 26, 2014 (TW) 103118239

(51) Int. Cl. G06Q 10/02; H04W 76/02; H04W 12/04; H04W 4/00

(52) U.S. Cl. CPC G06Q 10/02; H04W 4/008; H04W 76/023; H04W 12/04; G06Q 2220/10

(57) ABSTRACT

The invention discloses system and method for electronic ticket peer-to-peer (P2P) secure transfer on mobile devices by NFC Technology, which supports mobile devices with NFC such as cell phone, and tablet. Electronic Ticket P2P Secure transfers on mobile devices by NFC. The system and method comprises two mobile devices with NFC technology, each of which comprises a secure element, an electronic ticket platform sub-system and a check-tickets reader sub-system.

### BACKGROUND OF THE INVENTION

This application claims priority benefit of TW Patent Application Ser. No. 103118239 filed 2014 May 26 which is hereby incorporated herein by reference its entirety.

1. Field of the Invention

The present invention is related to a system, mobile device and method for electronic ticket peer-to-peer (P2P) secure transferring by near filed communication (NFC) technology. More particularly, the present invention is related to a system, mobile device and method which can transmit the electronic ticket of a user's mobile device to the other one user's mobile device by the P2P transferring mode or reader mode in NFC technology.

2. Description of the Prior Art

Thicket acts an import character in the social behavior of human society. The traditional paper ticket has following drawbacks: inconvenience ordering procedure, time-consuming queue issue, and complex and time-consuming verifying procedure, etc. Electronic ticket with the convenience property has become the mainstream solution of ticket market. The present technique most adopts two dimensions bar code as the electronic ticket (e.g. QR code), however, it exists several problems such as poor security, poor recognition, unable to order multiple tickets at one time, electronic ticket cannot be safely transferred to other device.

Traditional paper ticket purchase behavior comprises assisted purchase behavior. Assisted purchase behavior is that someone assists other people purchases tickets, and then handover the ticket to the consignor. However, in the previous electronic ticket system of mobile device, especially the aforementioned QR-code electronic ticket, the assisted purchase behavior is hard to bring into practice because the mobile device is hard to ensure the transmission security requirement such as verifying validity, security and correctively of ticket transferring, non-duplicate, etc. Therefore, the electronic ticket of mobile ticket technique is hard to promote until solved the aforementioned problem.

### SUMMARY OF THE INVENTION

Present application combines NFC technology to develop a system, mobile and method for electronic ticket P2P secure transferring. When the mobile device executing electronic ticket application software (APP), the electronic ticket can be purchased and downloaded from an electronic ticket selling platform which has cloud ordering/selling function, then the electronic ticket is stored and protected by the secure element (SE) in card emulation mode of the NFC technology. Then the ticket owner can use the electronic ticket to fast pass the ticket gate by offline ticket verifying mechanism, or transfer the ticket to other mobile device by the peer-to-peer (P2P) mode or reader mode of NFC technology. Present application provide the user enjoying the electronic ticket system by cloud ordering service, P2P security transferring service, and express offline ticket verifying service.

To achieve the aforementioned objectives, the present application provides a system for electronic ticket P2P secure transferring by NFC technology. Aforementioned system comprises two mobile devices supported the NFC technology, which are defined as first transmitting end mobile device and second receiving end mobile device. The first transmitting end mobile device is configured to transmit an electronic ticket transferring request to the second receiving end mobile device. Each mobile device comprises an application processor, a SE, and an NFC module.

Aforementioned application processor executes operation system software thereon. The operation system software comprises an operation system module, an NFC software module, and an electronic ticket application software module configured to process electronic ticket transferring operation.

Aforementioned SE comprises a central processor, a random access memory (RAM), a flash ROM and an electronic ticket applet which are electrically connected to the application processor. Wherein, the electronic ticket applet is used to store the electronic ticket and process electronic ticket transferring procedure between the transmitting end and the receiving end mobile devices. The applet further comprises electronic ticket secure storage operation, compression/decompression operation, encryption/decryption operation (including symmetric and asymmetric encryption/decryption). The application processor of mobile device calls APDU (application protocol data unit, ISO 7816) instruction to execute the applet stored in the SE so as to transmit the electronic ticket by P2P mode or reader mode of NFC transferring interface. Wherein, the transmitting end mobile device cooperates with the receiving end mobile device to process the compression, decompression, encryption, and decryption of the electronic ticket transferring operation.

Aforementioned NFC module comprises an NFC controller chip and inducting antenna electrically connected with the SE of the mobile device. The NFC module is configured to process the corresponding analog signal of electronic ticket transferring information.

The first transmitting end mobile device of aforementioned system further transmits the electronic ticket to the second receiving end mobile device by the NFC transferring interface, and removes/deletes/marks the original electronic ticket of the transmitting end mobile device after successfully accomplishing the transmission.

To achieve the aforementioned objective, the present application provides a system for electronic ticket P2P secure transferring by NFC technology. The system comprises an aforementioned mobile device, a backstage server device, and a ticket verifying system. The transmitting end mobile device connects to a cloud ticket selling platform by network connecting device, buys and downloads electronic ticket to the NFC SE (card emulation mode). And then the transmitting end mobile device transfers the electronic ticket to a receiving end mobile device by P2P mode or reader mode of NFC transferring interface.

The aforementioned backstage server device electronically connects with the cloud ticket selling platform so as to provide an electronic ticket purchasing service which provides mobile device linking and buying the tickets. The backstage server device further comprises electronic ticket database stored and executed server software. The server software comprises a ticket/web service module, mobile network interface, electronic ticket generating and secure encrypting module, a reader device verifying module, and a server operation system. The server software is used to receive electronic ticket purchase information from the transmitting end mobile device, process and generate an electronic ticket. Then the transmitting end mobile device downloads the ticket.

The aforementioned ticket verifying system further comprises a ticket verifying reader which is electrically connected with the backstage server device. When a mobile device with an electronic ticket prepares passing the ticket verifying sub-system, the ticket verifying reader processes a verification procedure and generates verification information, then the reader access the electronic ticket stored in the SE of mobile device. After decrypting and verifying the electronic ticket, the system mark or delete the electronic ticket stored in the SE, connects and enables a gate so as to allow user passing through.

The aforementioned transmitting end mobile device further transmits the electronic ticket to the receiving end mobile device by the NFC transferring interface, confirmed the thicket transferring to the other mobile device successfully, and then deletes the original electronic ticket of the transmitting end device.

To achieve the aforementioned objective, the present application provides a method for electronic ticket P2P secure transferring by NFC technology, the method applied in a mobile device and comprising following steps:

providing a first transmitting end mobile device and second receiving end mobile device, both of them support NFC function.

while the first transmitting end mobile device approaching/entering to the NFC transmitting range of the second receiving end mobile device, the transmitting end mobile device transmits a ticket transferring request to the second receiving end device. The first transmitting end mobile device further requests the user to enter a PIN number so as to ensure the transferring request is operated by the owner of the first transmitting end mobile device (ticket owner).

The first transmitting end mobile device and the second receiving end perform mutual authentication using verification information issued by the server device so as to verify each other. The aforementioned verification information comprises certification issued by server device, customized encryption key and related information.

Wherein the electronic ticket comprises two parts: part A and part B. Part A stores ticket content encrypted by the selling platform (using selling platform public key, PKₛₚ). The electronic ticket is decrypted and verified by aforementioned ticket verifying system (using selling platform private key, SKₛₚ). Part B stores system security information such as security chip/SE hardware serial number, ticket service provider code, transaction serial number, etc. The information of Part B is encrypted by the selling platform using the public key (PK_{S}) of the transmitting end mobile device. Then the part A and part B are merged, packaged and encrypted by a message authentication code (MAC) to form the electronic ticket.

The second receiving end mobile device transmits its hardware serial number of SE, certification information and public key (PK_{R}) thereof.

The first transmitting end mobile device uses MAC key to decompress and decrypt the ticket to be transmitted, decrypt Part B by the secret key of the transmitting end mobile device and replaces the hardware serial number in the Part B to the hardware serial number of the second receiving end mobile device, then encrypts the part B by the public key (PK_{R}) of the second receiving end mobile device, finally merges part A and part B, compresses and encrypts by the

MAC key to form the replaced electronic ticket.

The first transmitting end mobile device transmits the replaced electronic ticket to the second receiving end mobile device.

Receiving end mobile device stores the transferred electronic ticket to the SE, and the transmitting end mobile device deletes the original electronic ticket from the SE.

### BRIEF DESCRIPTION OF THE DRAWINGS

For a better understanding of the aforementioned embodiments of the invention as well as additional embodiments thereof, reference should be made to the Description of Embodiments below, in conjunction with the following drawings in which like reference numerals refer to corresponding parts throughout the figures.

FIG. 1 shows a system diagram of the ticket transferring system of present application.

FIG. 2 shows a circuit diagram of the ticket transferring system of present application.

FIG. 3 shows a portion circuit diagram of the ticket transferring system of present application.

FIG. 4 shows a flow chart of the ticket transferring method of present application.

### DETAILED DESCRIPTION OF THE PREFERRED EMBODIMENT

The following description is about embodiments of the present invention; however it is not intended to limit the scope of the present invention.

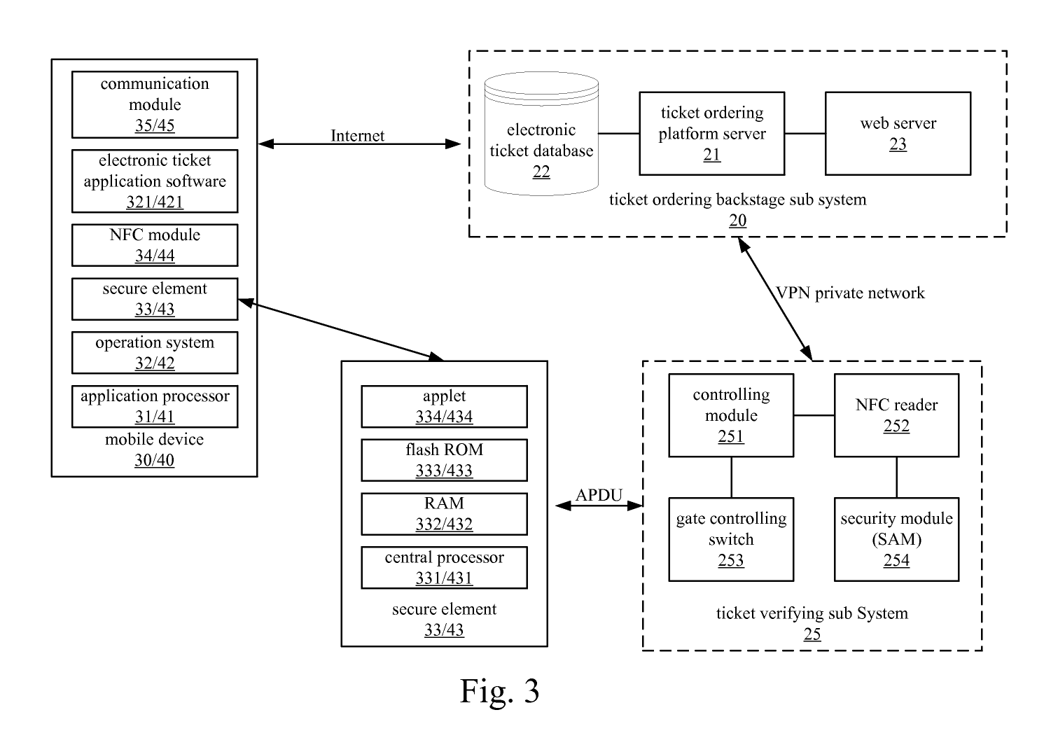

Please referring the FIG. 3, present application provides a mobile device set for electronic tickets P2P secure transferring by NFC technology. Aforementioned mobile device set comprises two mobile devices 30, 40 supporting NFC technology, and further be defined as first transmitting end mobile device 30 and second receiving end mobile device 40 for transmitting electronic ticket transferring information. Each mobile device comprises an application processor device 31/41, a SE 33/43. The application processor 31/41 executes an operation system software 32/42 thereon. The operation system software executes an electronic ticket application software 321/421 configured to process electronic ticket transferring information.

The SE 33/43 comprises a central processor 331/431, a random access memory (RAM) 332/432, a flash memory secure storage space 333/433, and an applet 334/434 which processing electronic ticket correlation operations. The SE electrically connects with the application processor 31/41 thought NFC module 34/44. Wherein the SE 33 of transmitting end mobile device configures to store electronic ticket and compress, encrypt, and decrypt the electronic ticket information. And the application processor 31 of transmitting end mobile device through APDU (Application protocol data unit, ISO 7816) calls and executes an applet 334/434 stored in SE, and transmits the electronic ticket using P2P transmission mode or reader mode of NFC transmission interface. Wherein the applet 434 of SE 43 of receiving end mobile device is configured to verify, receive, and store the electronic ticket. The NFC module 34/44 comprises an NFC controlling chip and inductive antenna which is electronically connected with application processor 31/41 and SE 33/43 of mobile device, and configures to process analog signal related to electronic ticket transferring information.

Present application further provides a system for electronic tickets P2P secure transferring by NFC technology. The system further comprises a mobile device 30/40, an electronic backstage server system 20, and a ticket verifying system 25.

The mobile device 30/40 electronically connects with a cloud ticket selling platform 20 by a network connecting device 35/45, purchases and downloads the electronic ticket (stores in the NFC SE 33). The transmitting end mobile device 30 further transmits the electronic ticket to the receiving end mobile device 40 by the P2P transmission mode or reader mode of NFC transmission interface when executing an electronic ticket transferring operation.

The electronic backstage server system 20 electronically connects with the Internet 27 and provides an electronic ticket purchase service so as to let the mobile device 30/40 to purchase electronic ticket by Internet. The electronic backstage server system 20 comprises an electronic ticket ordering server 21, an electronic ticket database 22, and a web server 23. The operation software of electronic ticket ordering server 21 further comprises a ticket/web service module, a mobile network connecting module, an electronic ticket generating and security encryption module, a ticket reader verifying and managing module, a bonus point adding module, and a server operation system. Aforementioned module and system are configured to receive and processes electronic ticket purchase request which sent by the mobile device, and then operates an online proceeding so as to transform the electronic ticket purchase request to an electronic ticket, downloads the electronic ticket to the mobile device 30/40 via Internet. The correlated ordering record is stored in the electronic ticket database 22.

The ticket verifying sub-system 25 electronically connects with the electronic ticket ordering server 21. The ticket verifying sub-system 25 further comprises a controlling module 251, an NFC reader 252, a gate controlling switch 253, and a security module (SAM) 254. When a mobile device with electronic ticket prepares to pass the gate, the controlling module 251 sends a verifying instruction to verify the electronic ticket through the NFC reader 252. Then the controlling module 251 access the electronic ticket stored in the SE 33/43 of mobile device 30/40. After decrypting and verifying the electronic ticket stored the SE by security module 254, then the controlling module 251 marks or deletes the electronic ticket of the SE 33/43, and enables the connected gate controlling switch 253 to open the gate so as to allow user passing through.

### EMBODIMENT

First, the user holds an NFC-enabled mobile device which equipped with a SE. Next, the user uses the mobile device downloading the electronic ticket application (electronic ticket APP) from the mobile software market. After executing the electronic ticket APP, user may select the electronic ticket ordering function to seek the ticket can be purchased. Then the user selects and purchases desired tickets by entering the purchase information. When the mobile device finished the purchase procedure, the electronic ticket is downloading from the cloud ticket service platform and be stored in the SE of the mobile device. The SE is a protected memory of the NFC chip which is used to store sensitive data or information. User may use the inquiring function of APP to inquire the purchased tickets and ordering history record. User may select the transferring function of APP to transfer one of the electronic tickets in the mobile device to other mobile device of receiving end user. When the receiving end user arrived the ticket verifying gate, the receiving end user takes the mobile device stored the transferred electronic tickets to approach/touch the reader so as to trigger the verifying system verifying the ticket and open the gate.

According to the usage scenarios, the system may provide following service: ordering ticket, refunding ticket, verifying ticket, transferring ticket and point adding service; the electronic ticket verifying platform may undertake the following request: ordering ticket, refunding ticket, verifying ticket, transferring ticket and point adding request. The function of reader is verifying and deleting the electronic ticket to ensure the used electronic ticket cannot be reused.

In one of usage scenarios, some user may order one or multiple electronic tickets by the present system. The electronic tickets could be downloaded and stored in the SE. User may select the transferring function of electronic ticket APP and choose one ticket to be transferred, and the mobile device then use P2P transmission mode or reader mode to securely transfer the selected ticket to another NFC-enabled receiving end mobile device. After finished the transferring procedure successfully, the electronic ticket in the original mobile device (transmitting end) will be removed to prevent the same electronic ticket be reused.

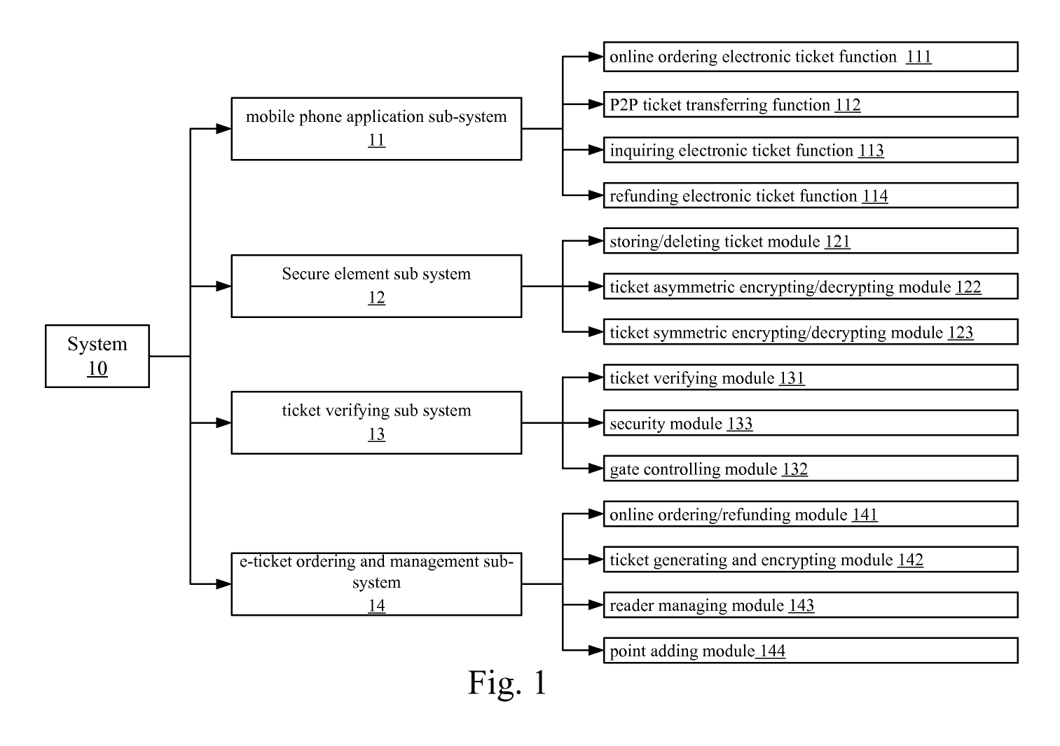

Please referring the FIG. 1, the system 10 of one embodiment of present application comprises following sub-systems: mobile phone application sub-system 11, SE sub-system 12, ticket verifying sub-system 13, and e-ticket ordering and management sub-system 14. The mobile phone application sub-system 11 is configured to provide users multiple services, such as online ordering electronic ticket function 111, P2P ticket transferring function 112, inquiring electronic ticket function 113, and refunding electronic ticket function 114. SE sub-system 12 comprises storing/deleting ticket module 121, ticket asymmetric encrypting/decrypting module 122 (e.g. RSA), and ticket symmetric encrypting/decrypting module 123 (e.g. MAC). The ticket verifying sub-system 13 comprises a ticket verifying module 131, gate controlling module 132, and security module 133. Electronic ordering backstage server sub-system comprises an online ordering/refunding module 141, a ticket generating and encrypting module 142, a reader managing module 143, and a point adding module 144.

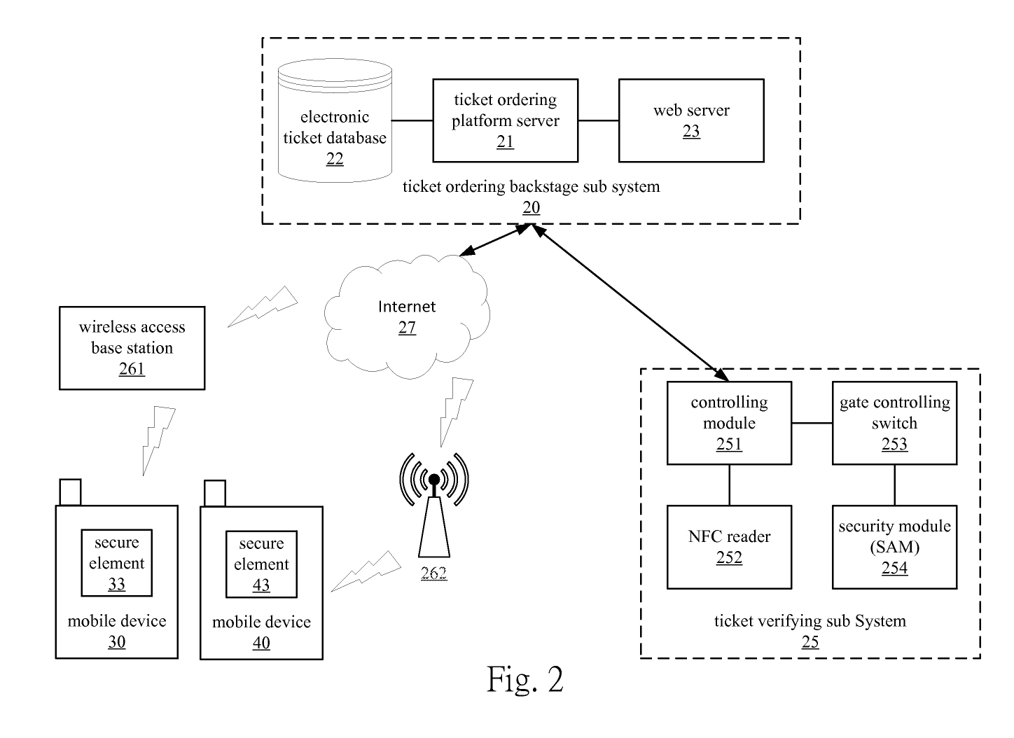

FIG. 2 shows a system structure diagram of present application. The system comprises a ticket ordering backstage sub-system 20 which comprising an electronic ticket ordering platform server 21, an electronic ticket database 22, and a web server 23. When the system is in operation, the mobile device 30/40 connects to the electronic ticket ordering platform server 21 through the wireless access base station 261/mobile communication base station 262 and Internet 27.

Referring the FIG. 2, wherein the ticket verifying sub-system 25 comprises a controlling module 251, NFC reader 252, gate controlling switch 253, and a security module (SAM) 254. The ticket verifying sub-system 25 electronically connects with the reader managing module 143 by the network, and acquires batch of MAC keys and RSA private keys SKsp for decompressing and decrypting the electronic ticket. The MAC key and RSA private key is stored in the SAM 254 of the ticket verifying sub-system 25 so as to provide offline express ticket verifying service without online linking to the backstage system.

FIG. 3 further explains the mobile device 30/40 and SE 33/43. The mobile device sub-system comprises an application processor 31/41, operation system 32/42, SE 33/43, NFC module (including NFC controlling chip and inducting antenna) 34/44, electronic ticket APP software, and communication module (3G/4G/Wi-Fi) 35/45. SE 33/43 further comprises microprocessor 331/431 memory 332/432, flash memory security storage space 333/433, and electronic ticket applet 334/434.

Electronic Ticket System Platform

The electronic ticket system platform provides user online inquiring the ticket, ordering ticket and receiving ordered ticket information by the APP of mobile device, then synchronizing electronic ticket information. One of functions of mobile device is that synchronizing and communicating with the SE in the ordering procedure to ensure the data consistency. The software instruction applied in the mobile device calls the electronic ticket applet to encrypt/decrypt data or transmit the electronic ticket to the SE. One of functions of reader is that it synchronizes electronic ticket information with the server, reads and verifies the electronic ticket stored in the SE of the mobile device when the mobile device passing through.

Aforementioned four sub-systems of present application are constructed on following four elements respectively: backstage server, NFC-enabled mobile device, NFC SE, and ticket verifying reader. Backstage server comprises an application server and a database. The application server provides the electronic ticket ordering APP to order or inquire the electronic ticket, and the database stores tickets for sale and records of sold tickets. The mobile device is configured to execute an electronic ticket ordering APP including ordering electronic ticket, transferring electronic ticket, using electronic ticket, refunding electronic ticket, adding point, browsing history records, etc. SE is a hardware device configured on the motherboard or SIM card of mobile device. The SE comprises several independent secure domain memory where the Applet program can be installed on it. The applet can be written by Java or other languages. The applet comprises APDU functions provided the processor calling and executing. In one of embodiment, the Java applet stored in security domain of SE supports following APDU functions: storing electronic ticket, encrypt/decrypt electronic ticket, transferring electronic ticket, etc. The ticket verifying reader supports offline electronic ticket verifying function. In present embodiment, the aforementioned circuit developing structure is shown in FIG. 3.

In the system linking/communicating mode of present application, service provider (ticket content provider) registers and provides the electronic ticket format to the platform because the format of electronic tickets of each service provider may be different. And the platform also provides the user information to the service provider. The service provider puts the verifying information to the security module (SAM) of reader by the VPN private network. Then the ticket reader transmits APDU instruction to mobile device by contactless card reader interface to achieve communicating purpose.

### Electronic Transferring Function

Transmitter end user needs to executes the electronic ticket APP of mobile device and selects the electronic ticket transferring option, when the receiving end mobile device entering transmitting/reading range of the transmitter end mobile device, the receiving end mobile device shows the message noticed whether receiving the ticket (comprising verifying/refuse option). When the receiving end user selects the verifying option, then the two mobile devices can finish the transferring operation. After successfully transferring the electronic ticket, the electronic ticket will be deleted or removed.

Electronic Ticket Peer to Peer Mode Transferring Procedure

In the P2P transferring mode of one embodiment, one of important steps is that exchange the transmitting end hardware serial number (IC#) of the SE in the part B of the electronic ticket to the receiving end hardware serial number (IC#). Therefore, when the receiving end mobile passing through the gate, the verifying system can analyze the content of the electronic ticket and compares the hardware serial number in the electronic ticket and the hardware serial number of the receiving end mobile device so as to determine two serial numbers whether as same as to each other. That is, aforementioned procedure can verify that the receiving end mobile device whether the legal holder of the electronic ticket. In another words, even though the electronic ticket is illegal stolen to another mobile device, the illegal electronic ticket still can't pass the hardware serial number checking procedure.

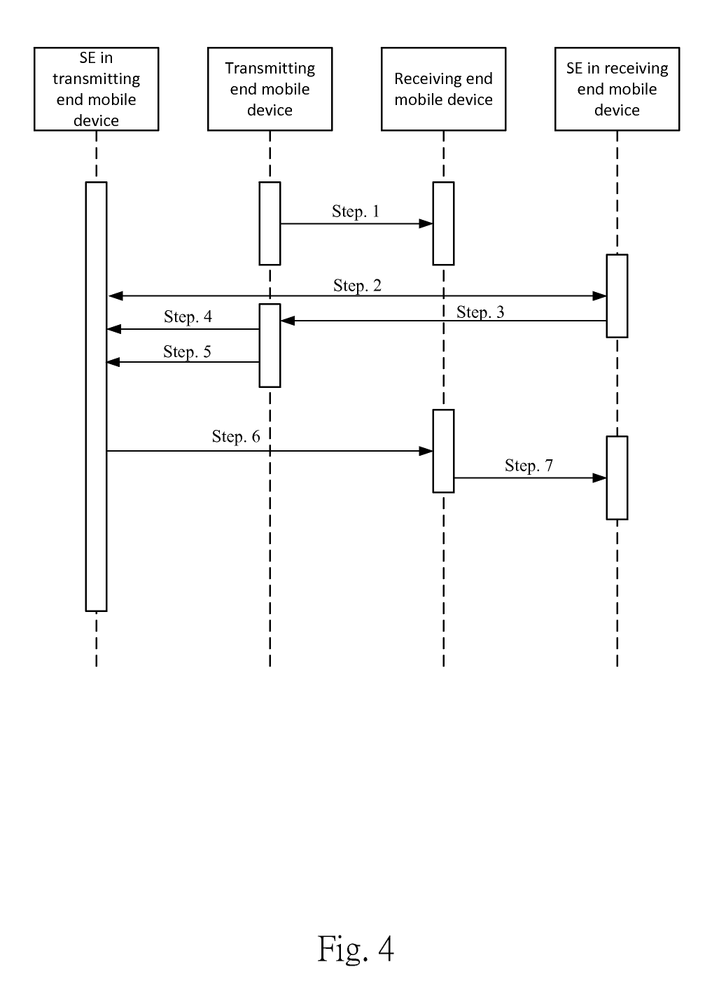

The detailed procedure and steps is shown in FIG. 4 and following description:

Step 1. Transmitting end mobile device 30 transmits an electronic ticket transferring request to receiving end mobile device 40.

Step 2. Two mobile devices 30/40 verifies to each other by verification information provided by server.

Step 3. After finishing the verifying procedure, the receiving end mobile 40 sends the own hardware serial number and public key PK_{R} to transmitting end mobile device 30.

Step 4. Transmitting end mobile device 30 call the applet of SE to check and decompress MAC information of electronic ticket.

Step 5. After successfully checking and decompressing the MAC information, the applet 334 of SE of transmitting end mobile device decrypts the Part B of the electronic ticket by the own private key SK_{S}, and replaces the own serial number of Part B to the serial number of receiving end mobile device. Then, the transmitting end mobile device encrypts the replaced electronic ticket by the public key PK_{R} of receiving end mobile device, and adds new MAC encrypting compression message to form a new electronic ticket.

Step 6. Transmitting end mobile device 30 transmits the new electronic ticket to the receiving end mobile device 40.

Step 7. Receiving end mobile device calls the applet 434 of SE 43 so as to store the new electronic ticket in the SE 43.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A mobile device for electronic ticket secure transferring by NFC technology comprising:
an application processor, configured to execute a operation system software, the operation system software comprising an electronic ticket application software module;
an NFC SE, comprising an electronic ticket, the NFC SE being connected with the application processor, the electronic ticket comprising a hardware serial number;
an NFC module, connected with the NFC SE and the application processor, the NFC module being configured to communicate with an external receiving end mobile device;
wherein, when the application processor executes the electronic ticket application software module, the application processor replaces the original hardware serial number to the serial number of the receiving end mobile device, and transmits the replaced electronic ticket to the receiving end mobile by the NFC module.

2. The device as claimed in claim 1, further automatically deleting the electronic ticket stored in the SE after finishing the transmission.

3. The device as claimed in claim 1, wherein the hardware serial number is NFC SE hardware serial number.

4. The device as claimed in claim 1, wherein the application processor further decrypts the original electronic ticket by a private key of the mobile device so as to replace the original hardware serial number to the hardware serial number of the receiving end mobile device, and encrypts the replaced electronic ticket by a public key of the receiving end mobile device.

5. The device as claimed in claim 1, wherein the application processor calls application protocol data instruction of an electronic ticket applet of the NFC SE to execute an electronic ticket transferring operation.

6. A system for electronic ticket peer to peer secure transferring by NFC technology, the system comprising:
a mobile device as claimed in claim 1, being configured to connect with a cloud ticket selling platform by the network connecting device to purchase and download an electronic ticket to an NFC SE of the mobile device, and the mobile device further transmits the electronic ticket to a receiving end mobile device by an NFC transmitting interface;
a server device, being configured to electronically connect with the cloud ticket selling platform so as to provide the mobile device to purchase the electronic ticket;
a ticket verifying system, comprising a ticket verifying reader which electronically connected with the server device, wherein when the receiving end mobile device proceeding a verification procedure, the ticket verifying sub-system acquires the electronic ticket from the receiving end mobile device by the ticket verifying reader and determines whether providing verification information, wherein the ticket verifying sub-system further accesses the electronic ticket of the receiving end mobile device, decrypts and verifies content of the electronic ticket, then determines to mark or delete the electronic ticket stored in the NFC SE of the receiving end mobile device, connects and enables a gate to allow user passing through.

7. A method for electronic ticket P2P secure transferring by NFC technology, the method applied in a mobile device and comprising following steps:
transmitting a ticket transferring request to an external receiving mobile device so as to proceed a verify procedure with the receiving mobile device;
replacing the original hardware serial number of the electronic ticket of the transmitting end mobile device to the hardware serial number of the receiving end mobile device;
transmitting the replaced electronic ticket to the receiving end device.

8. The method as claimed in claim 7, further automatically deleting the electronic ticket stored in the mobile device after finishing the transmission.

9. The method as claimed in claim 7, wherein the hardware serial number is NFC SE hardware serial number.

10. The method as claimed in claim 7, further decrypts electronic ticket by a private key of the mobile device so as to replace the original hardware serial number to the hardware serial number of the receiving end mobile device, and encrypts the replaced electronic ticket by a public key of the receiving end mobile device.
